(19) United States
(12) Patent Application Publication
(10) Pub. No.: US 2019/0005070 A1
(43) Pub. Date: Jan. 3, 2019

(54) EMOJI SEARCHING METHOD AND APPARATUS

(71) Applicant: BAIDU ONLINE NETWORK TECHNOLOGY (BEIJING) CO., LTD, Haidian District Beijing (CN)

(72) Inventors: Yi LI, Beijing (CN); Haixiang YANG, Beijing (CN); Yilan HAN, Beijing (CN)

(73) Assignee: BAIDU ONLINE NETWORK TECHNOLOGY (BEIJING) CO., LTD ., Haidian District Beijing (CN)

(21) Appl. No.: 16/011,382

(22) Filed: Jun. 18, 2018

(30) Foreign Application Priority Data
Jun. 30, 2017 (CN) 2017105215959

(51) Int. Cl. G06F 17/30

(52) U.S. Cl. CPC G06F 17/30268; G06F 17/30389; G06F 17/3028; G06F 17/30569

(57) ABSTRACT

The present disclosure provides an emoji searching method and apparatus, comprising: receiving an image search text input by a user; converting the image search text input by the user into a words form; obtaining an image search result corresponding to the image search text in the words form; returning the image search result to the user. Use of the technical solutions of embodiments of the present disclosure can avoid problems in the prior art such as failure to recognize emoji-related special characters, search errors, or return of irrelevant results during image search, and can implement understanding of the meaning of emojis and automatic matching with the image search result. This assists users having a habit of inputting emojis in performing image search more conveniently.

The present application claims the priority of Chinese Patent Application No. 2017105215959, filed on Jun. 30, 2017, with the title of “Emoji searching method and apparatus”. The disclosure of the above applications is incorporated herein by reference in its entirety.

### FIELD OF THE DISCLOSURE

The present disclosure relates to the field of Internet application, and particularly to an emoji searching method and apparatus.

### BACKGROUND OF THE DISCLOSURE

Emojis, as emotion symbols, derive from a Japanese term “ [symbol] ” in Kana, pronounced as emoji). Emojis can enable people to feel digital communication as face-to-face communication, and avoid wrong information conveyance. Emojis have already been supported by most modern computer and mobile phone operating systems such as Windows, macOS, Android and iOS, and universally applied to various mobile phone short messages, instant communication and social network. As mobile internet big data develop, emojis are used more and more frequently, serve as a second mobile networking language, are equivalent to half a mother tongue, and carry more meaning and information.

Image searching engines in China mostly do not support search for emojis. Special characters related to emojis cannot be identified in image search, or the search goes wrong or irrelevant results are returned

### SUMMARY OF THE DISCLOSURE

A plurality of aspects of the present disclosure provide an emoji searching method and apparatus, to help users who have a habit of inputting emojis to perform image search more conveniently.

According to an aspect of the present disclosure, there is provided an emoji searching method, comprising:

receiving an image search text input by a user;

converting the image search text input by the user into a words form;

obtaining an image search result corresponding to the image search text in the words form;

returning the image search result to the user.

The above aspect and any possible implementation mode further provide an implementation mode:

the image search text is an emoji; or

a text including an emoji and words.

The above aspect and any possible implementation mode further provide an implementation mode: the converting the image search text input by the user into a words form comprises:

detecting whether the image search text input by the user includes an emoji;

looking up for a term result corresponding to the emoji included in the image search text input by the user;

using the term result to replace the emoji, and converting the image search text including the emoji into the image search text in the words form.

The above aspect and any possible implementation mode further provide an implementation mode: the detecting whether the image search text input by the user includes an emoji comprises:

converting the image search text input by the user into a unicode code;

performing regular expression judgment for the unicode code to screen out an emoji unicode.

The above aspect and any possible implementation mode further provide an implementation mode: the obtaining an image search result corresponding to the image search text in the words form comprises:

an image search engine obtains a search result item according to the image search text in the words form acquired from the conversion.

The above aspect and any possible implementation mode further provide an implementation mode: the search result item further comprises:

after receiving the image search text in the words form after the conversion, the image search engine performs search in pre-built image text information indices to acquire an index matched with the image search text in the words form after the conversion; then obtains an image corresponding to the index matched with the image search text in the words form after the conversion, and generates a search result item.

According to another aspect of the present disclosure, there is provided an emoji searching apparatus, comprising an input module, a conversion module, an acquisition module and a display module; wherein,

the input module is configured to receive an image search text input by a user;

the conversion module is configured to convert the image search text input by the user into a words form;

the acquisition module is configured to acquire an image search result corresponding to the image search text in the words form;

the display module is configured to return the image search result to the user.

The above aspect and any possible implementation mode further provide an implementation mode:

the image search text is an emoji; or

a text including an emoji and words.

The above aspect and any possible implementation mode further provide an implementation mode: the conversion module further comprises:

a detection submodule configured to detect whether the image search text input by the user includes an emoji;

a lookup submodule configured to looks up for a term result corresponding to the emoji included in the image search text input by the user;

a replacement submodule configured to use the term result to replace the emoji, and convert the image search text including the emoji into the image search text in the words form.

The above aspect and any possible implementation mode further provide an implementation mode: the detecting whether the image search text input by the user includes an emoji comprises:

converting the image search text input by the user into a unicode code; performing regular expression judgment for the unicode code to screen out an emoji unicode.

The above aspect and any possible implementation mode further provide an implementation mode: the acquisition module is further configured to perform:

receiving a search result item acquired according to the image search text in the words form acquired from conversion.

The above aspect and any possible implementation mode further provide an implementation mode: when the search result item acquired according to the image search text in the words form acquired from conversion is received, the following is specifically performed:

after receiving the image search text in the words form after the conversion, performing search in pre-built image text information indices to acquire an index matched with the image search text in the words form after the conversion; then obtaining an image corresponding to the index matched with the image search text in the words form acquired from the conversion, and generating a search result item.

According to a further aspect of the present disclosure, there is provided an apparatus, wherein the apparatus comprises:

one or more processors;

a storage device for storing one or more programs,

when said one or more programs are executed by said one or more processors, said one or more processors are enabled to implement the above-mentioned method.

According to a further aspect of the present disclosure, there is provided a readable storage medium on which a computer program is stored, wherein the program, when executed by a processor, implements the above-mentioned method.

As known from the above technical solutions, the embodiments of the present disclosure provide an emoji searching method and apparatus, comprising: receiving an image search text input by a user; converting the image search text input by the user into a words form; obtaining an image search result corresponding to the image search text in the words form; returning the image search result to the user. The present disclosure assists users having a habit of inputting emojis in performing image search more conveniently.

### BRIEF DESCRIPTION OF DRAWINGS

To describe technical solutions of embodiments of the present disclosure more clearly, figures to be used in the embodiments or in depictions regarding the prior art will be described briefly. Obviously, the figures described below are only some embodiments of the present disclosure. Those having ordinary skill in the art appreciate that other figures may be acquired from these figures without making inventive efforts.

FIG. 1 is a flow chart of an emoji searching method according to an embodiment of the present disclosure;

FIG. 2 is a flow chart of converting an image search text input by a user into a words form in an emoji searching method according to an embodiment of the present disclosure;

FIG. 3 is a block diagram of an emoji searching apparatus according to another embodiment of the present disclosure;

FIG. 4 is a block diagram of a conversion module of an emoji searching apparatus according to another embodiment of the present disclosure;

FIG. 5 is a block diagram of an exemplary computer system/server adapted to implement the embodiment of the present disclosure;

FIG. 6 is a schematic diagram of a search result of an image search text only including an emoji according to an embodiment of the present disclosure;

FIG. 7 is a schematic diagram of a search result of a text search text including an emoji and words according to an embodiment of the present disclosure.

### DETAILED DESCRIPTION OF PREFERRED EMBODIMENTS

To make objectives, technical solutions and advantages of embodiments of the present disclosure clearer, technical solutions of embodiment of the present disclosure will be described clearly and completely with reference to figures in embodiments of the present disclosure. Obviously, embodiments described here are partial embodiments of the present disclosure, not all embodiments. All other embodiments acquired by those having ordinary skill in the art based on the embodiments of the present disclosure, without making any inventive efforts, fall within the protection scope of the present disclosure.

In addition, the term “and/or” used in the text is only an association relationship depicting associated objects and represents that three relations might exist, for example, A and/or B may represents three cases, namely, A exists individually, both A and B coexist, and B exists individually. In addition, the symbol “/” in the text generally indicates associated objects before and after the symbol are in an “or” relationship.

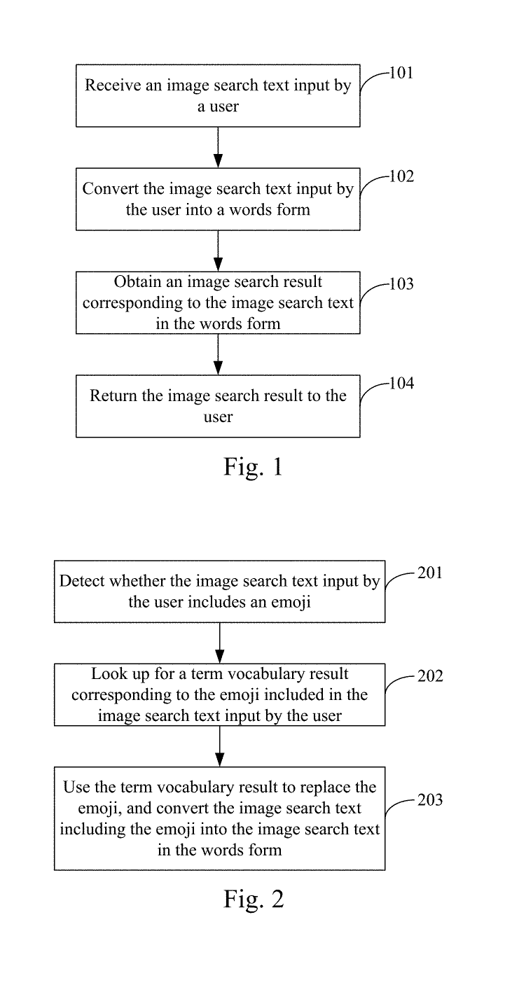

FIG. 1 is a flow chart of an emoji searching method according to an embodiment of the present disclosure. As shown in FIG. 1, the method comprises the following steps:

In 101 is received an image search text input by a user;

Specifically, the user may access an image search engine from any electronic device. Electronic devices may specifically comprise devices such as a smart phone, a tablet computer, a notebook computer and a desktop computer. Operating systems installed on the devices comprise but are not limited to iOS, Android, Windows and MacOS. A mobile terminal such as a smart phone is taken as an example in the present embodiment. The user opens a search page from a browser built in the mobile terminal. The search page includes a search box. The user inputs in the search box an image search text via an input method built in the mobile terminal and supporting emojis. The search page packs the image search text in a search request, and sends the search request to the image search engine to request the image search engine to search for images related to the image search text.

The image search text may be a text only including an emoji such as [symbol] , or a text including an emoji and characters such as Chinese and/or English characters, for example, [symbol] .

In 102, the image search text input by the user is converted into a words form; specifically, the step comprises the following substeps as shown in FIG. 2:

In 201, the image search engine detects whether the image search text input by the user includes an emoji;

performs JSON encoding for the received text that might include an emoji, convert the emoji in the text into a unicode code; establish a matching rule interval in a encoding range in the unicode according to the emoji, and screen the unicode code through a regular expression to get an emoji unicode.

The matching rule interval is as follows:

| | |
|---|---|
| <U+1F300> - <U+1F5FF> | # symbols & pictographs |
| <U+1F600> - <U+1F64F> | # emoticons |
| <U+1F680> - <U+1F6FF> | # transport & map symbols |
| <U+2600> - <U+2B55> | # other |

Wherein the unicode code of [symbol] is 1F339, and may be screened out through the above regular expression.

In 202, the image search engine looks up for a term result corresponding to the emoji included in the image search text input by the user;

The image search engine looks up a pre-established unicode and term mapping table for a Shortcodes description corresponding to the emoji unicode, namely, namely an official meaning corresponding thereto.

In 203, the image search engine uses the term result to replace the emoji, and converts the image search text including the emoji into an image search text in a words form.

Preferably, it is feasible to use the regular expression to screen out the emoji unicode from the text, perform binary packing for it, perform UTF8 transcoding, and then put it back in the original text.

For example, regarding [symbol] , the term result corresponding to its unicode 1F339 is rose, and then [symbol] is converted into a rose.

For example, regarding [symbol] , the term result corresponding to the unicode 1F339 of [symbol] is rose, and then [symbol] is converted into a rose, and the text is converted into rose [symbol] (rose tea).

In 103 is acquired an image search result corresponding to the image search text in the words form acquired from conversion;

The image search engine is configured to perform image search, provide an image search result that may be displayed by the browser, and return the image search result to the user.

The image search engine performs search in pre-built image text information indices according to the image search text in the words form acquired from conversion to acquire an index matched with the image search text in the words form acquired from conversion; then obtains an image corresponding to the index matched with the image search text in the words form acquired from conversion, generates a search result item, and sends the search result item to the browser.

In an implementation mode of the present embodiment, furthermore, before converting the image search text input by the user into the words form, the image search engine analyzes content of a crawled image and obtains text information of the image.

In another implementation mode of the present embodiment, furthermore, before converting the image search text input by the user into the words form, the image search engine analyzes content of the crawled image and analyzes a text of a webpage where the image lies, and obtains text information of the image.

Specifically, analyzing the content of the crawled image may be: analyzing at least one of object information, scenery information, character information and words information in the crawled image. That is to say, analyzing from perspective of content of the image includes but is not limited to analyzing at least one of information in the image such as object information, scenery information, character information and words information.

Specifically, analyzing the text of the webpage where the crawled image lies may be: analyzing structured text fields of the webpage where the crawled image lies. The structured text fields of the webpage where the crawled image lies include a webpage topic description field of the webpage, a text field around the image and/or an image attribute field.

In the above two implementation modes, after obtaining the text information of the crawled image and before receiving the image search text in the words form acquired from conversion, the search engine may further arrange the text information of the image, and establish an index matched with the above search keyword.

Specifically, the search engine may arrange the text information of the image in a way that the search engine performs words segmentation for the text information of the image, and considers a words segmentation result as input of keyword extraction. The keyword extracted here includes a single word which is usually used as well as a compound word which can convey the meaning of the image more accurately and more pluralistically, namely, the compound word is formed by more than two words in collocation.

Extracting the word as the keyword means performing stop word filtration for the words segmentation result for the text information of the image, and extracting a word with a preset part of speech as the keyword, usually extracting a proper noun as the keyword.

Extracting a collocation of more than two words as the keyword means extracting, from the words segmentation result for the text information of the image, a collocation of more than two words that satisfy a preset word collocation mode as the keyword.

According to the above method, the description of the text information of the image is added, so it is possible to return more better-related images upon search, and thereby better satisfy the user's demands and improve the user's experience.

The generating the search result item comprises: extracting and parsing abstract information of the image search result, and generating the search result item including an image, an image abstract, a words abstract and a source.

In the present embodiment, the abstract information of the image search result is extracted, and the abstract information of the image search result is further parsed to acquire the image abstract, the words abstract, the source and the like. The image abstract is generally a thumbnail of the image; the words abstract generally includes a title, keywords, and description; the source generally includes a field such as a URL address. The search result items are generated according to the above information.

In 104, the image search result is returned to the user.

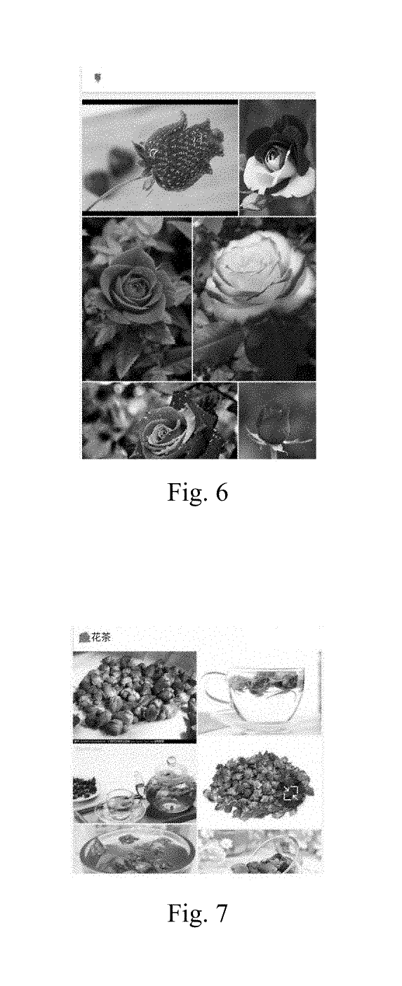

In a search result page, the search result items are ranked and displayed to the user, as shown in FIG. 6 and FIG. 7.

When the search result items are displayed to the user, it is necessary to rank related images, and calculate, according to a ranking algorithm, which images should be ranked ahead.

Preferably, the ranking is performed by calculating similarity between the keyword of the image and the image search text. The larger the similarity is, the more ahead the image is ranked.

Preferably, the ranking algorithm may be making statistics of groups of users' historical click frequencies of the image. The higher the click rate is, the more ahead the image is ranked.

As appreciated, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, different emphasis is placed on respective embodiments, and reference may be made to related depictions in other embodiments for portions not detailed in a certain embodiment.

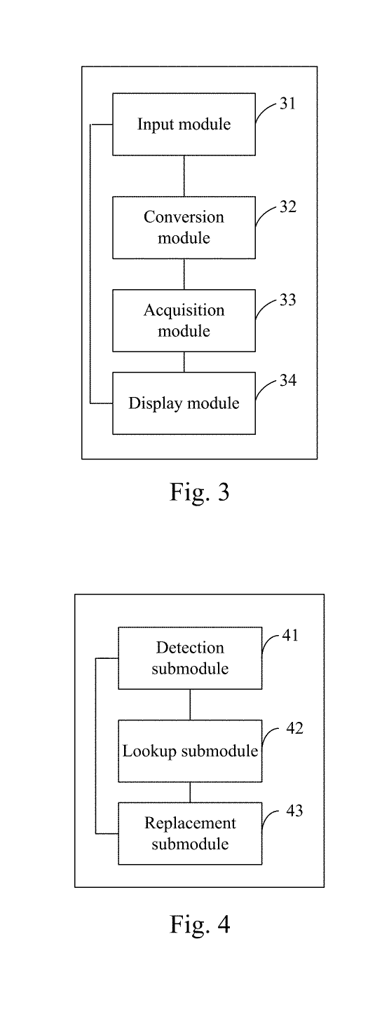

FIG. 3 is a block diagram of an emoji searching apparatus according to another embodiment of the present disclosure. As shown in FIG. 3, the apparatus comprises an input module 31, a conversion module 32, an acquisition module 33 and a display module 34; wherein,

The input module 31 is configured to receive an image search text input by a user;

Specifically, the user may access an image search engine from any electronic device. Electronic devices may specifically comprise devices such as a smart phone, a tablet computer, a notebook computer and a desktop computer. Operating systems installed on the devices comprise but are not limited to iOS, Android, Windows and MacOS. A mobile terminal such as a smart phone is taken as an example in the present embodiment. The user opens a search page from a browser built in the mobile terminal. The search page includes a search box. The user inputs in the search box an image search text via an input method built in the mobile terminal and supporting emojis. The search page packs the image search text in a search request, and sends the search request to the image search engine to request the image search engine to search for images related to the image search text.

The image search text may be a text only including an emoji such as [symbol] , or a text including an emoji and characters such as Chinese and/or English characters, for example, [symbol] .

The conversion module 32 is configured to convert the image search text input by the user into a words form; specifically, the conversion module comprises the following submodules as shown in FIG. 4:

A detection submodule 41 configured to detect whether the image search text input by the user includes an emoji;

perform JSON encoding for the received text that might include an emoji, convert the emoji in the text into a unicode code; establish a matching rule interval in a encoding range in the unicode according to the emoji, and screen the unicode code through a regular expression to get an emoji unicode.

The matching rule interval is as follows:

| | |
|---|---|
| <U+1F300> - <U+1F5FF> | # symbols & pictographs |
| <U+1F600> - <U+1F64F> | # emoticons |
| <U+1F680> - <U+1F6FF> | # transport & map symbols |
| <U+2600> - <U+2B55> | # other |

Wherein the unicode code of [symbol] is 1F339, and may be screened out through the above regular expression.

A lookup submodule 42 configured to looks up for a term result corresponding to the emoji included in the image search text input by the user;

The lookup submodule looks up a pre-established unicode and term mapping table for a Shortcodes description corresponding to the emoji unicode, namely, namely an official meaning corresponding thereto.

A replacement submodule 43 configured to use the term result to replace the emoji, and convert the image search text including the emoji into an image search text in a words form.

Preferably, it is feasible to use the regular expression to screen out the emoji unicode from the text, perform binary packing for it, perform UTF8 transcoding, and then put it back in the original text.

For example, regarding [symbol] , the term result corresponding to its unicode 1F339 is rose, and then [symbol] is converted into a rose.

For example, regarding [symbol] , the term result corresponding to the unicode 1F339 of [symbol] is rose, and then [symbol] is converted into a rose, and the text is converted into rose [symbol] (rose tea).

An acquisition module 33 configured to acquire an image search result corresponding to the image search text in the words form acquired from conversion;

Specifically, the acquisition module 33 is configured to acquire a search result item from a database according to the image search text in the words form acquired from conversion;

The image search engine is configured to perform image search, provide an image search result that may be displayed by the browser, and return the image search result to the user.

The acquisition module 33 performs search in pre-built image text information indices according to the image search text in the words form acquired from conversion to acquire an index matched with the image search text in the words form acquired from conversion; then obtains an image corresponding to the index matched with the image search text in the words form acquired from conversion, generates a search result item, and sends the search result item to the browser.

In an implementation mode of the present embodiment, furthermore, the emoji searching apparatus further comprises a content analyzing module configured to, before converting the image search text input by the user into the words form, analyze content of a crawled image and obtain text information of the image.

In another implementation mode of the present embodiment, furthermore, the emoji searching apparatus further comprises a content analyzing module configured to, before converting the image search text input by the user into the words form, analyze content of the crawled image and analyze a text of a webpage where the image lies, and obtain text information of the image.

Specifically, analyzing the content of the crawled image may be: analyzing at least one of object information, scenery information, character information and words information in the crawled image. That is to say, analyzing from perspective of content of the image includes but is not limited to analyzing at least one of information in the image such as object information, scenery information, character information and words information.

Specifically, analyzing the text of the webpage where the crawled image lies may be: analyzing structured text fields of the webpage where the crawled image lies. The structured text fields of the webpage where the crawled image lies include a webpage topic description field of the webpage, a text field around the image and/or an image attribute field.

In the above two implementation modes, after obtaining the text information of the crawled image and before receiving the image search text in the words form acquired from conversion, the search engine may further arrange the text information of the image, and establish an index matched with the above search keyword.

Specifically, the search engine may arrange the text information of the image in a way that the search engine performs words segmentation for the text information of the image, and considers a words segmentation result as input of keyword extraction. The keyword extracted here includes a single word which is usually used as well as a compound word which can convey the meaning of the image more accurately and more pluralistically, namely, the compound word is formed by more than two words in collocation.

Extracting the word as the keyword means performing stop word filtration for the words segmentation result for the text information of the image, and extracting a word with a preset part of speech as the keyword, usually extracting a proper noun as the keyword.

Extracting a collocation of more than two words as the keyword means extracting, from the words segmentation result for the text information of the image, a collocation of more than two words that satisfy a preset word collocation mode as the keyword.

According to the above method, the description of the text information of the image is added, so it is possible to return more better-related images upon search, and thereby better satisfy the user's demands and improve the user's experience.

The generating the search result item comprises: extracting and parsing abstract information of the image search result, and generating the search result item including an image, an image abstract, a words abstract and a source.

In the present embodiment, the abstract information of the image search result is extracted, and the abstract information of the image search result is further parsed to acquire the image abstract, the words abstract, the source and the like. The image abstract is generally a thumbnail of the image; the words abstract generally includes a title, keywords, and description; the source generally includes a field such as a URL address. The search result items are generated according to the above information.

A display module 34 configured to return the image search result to the user.

In a search result page, the search result items are ranked and displayed to the user, as shown in FIG. 6 and FIG. 7.

When the search result items are displayed to the user, it is necessary to rank related images, and calculate, according to a ranking algorithm, which images should be ranked ahead.

Preferably, the ranking is performed by calculating similarity between the keyword of the image and the image search text. The larger the similarity is, the more ahead the image is ranked.

Preferably, the ranking algorithm may be making statistics of groups of users' historical click frequencies of the image. The higher the click rate is, the more ahead the image is ranked.

Those skilled in the art may clearly understand for the sake of convenient and brief description, a specific working procedure of the aforesaid apparatus is not detailed any more here and reference may be made to the corresponding procedure in the above method embodiment.

The above embodiments of the present disclosure can avoid problems in the prior art such as failure to recognize emoji-related special characters, search errors, or return of irrelevant results during image search, and can implement understanding of the meaning of emojis and automatic matching with the image search result. This assists users having a habit of inputting emojis in performing image search more conveniently.

In the embodiments provided by the present disclosure, it should be understood that the revealed system and method can be implemented in other ways. For example, the above-described embodiments for the apparatus are only exemplary, e.g., the division of the units is merely logical one, and, in reality, they can be divided in other ways upon implementation. For example, a plurality of units or components may be combined or integrated into another system, or some features may be neglected or not executed. In addition, mutual coupling or direct coupling or communicative connection as displayed or discussed may be indirect coupling or communicative connection performed via some interfaces, means or units and may be electrical, mechanical or in other forms.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

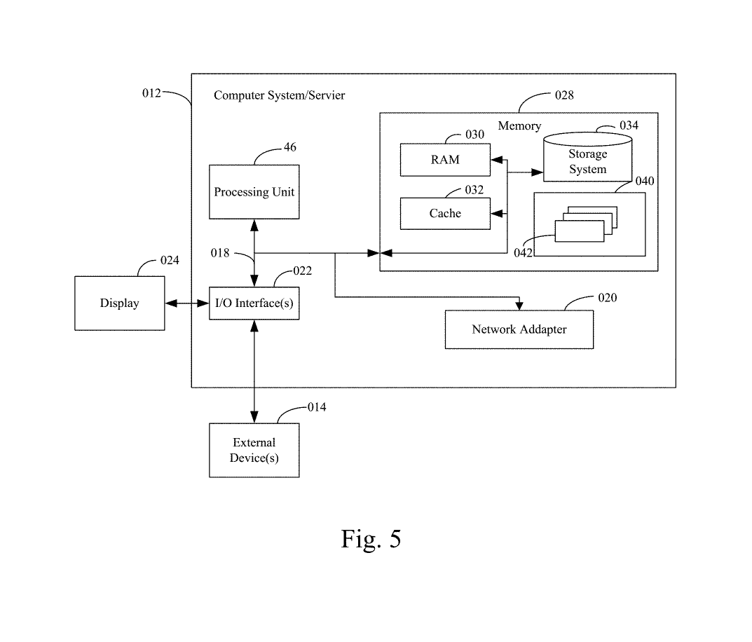

FIG. 5 illustrates a block diagram of an example computer system/server 012 adapted to implement an implementation mode of the present disclosure. The computer system/server 012 shown in FIG. 5 is only an example and should not bring about any limitation to the function and scope of use of the embodiments of the present disclosure.

As shown in FIG. 5, the computer system/server 012 is shown in the form of a general-purpose computing device. The components of computer system/server 012 may include, but are not limited to, one or more processors or processing units 016, a memory 028, and a bus 018 that couples various system components including system memory 028 and the processor 016.

Bus 018 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 012 typically includes a variety of computer system readable media. Such media may be any available media that is accessible by computer system/server 012, and it includes both volatile and non-volatile media, removable and non-removable media.

Memory 028 can include computer system readable media in the form of volatile memory, such as random access memory (RAM) 030 and/or cache memory 032. Computer system/server 012 may further include other removable/non-removable, volatile/non-volatile computer system storage media. By way of example only, storage system 034 can be provided for reading from and writing to a non-removable, non-volatile magnetic media (not shown in FIG. 5 and typically called a “hard drive”). Although not shown in FIG. 5, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 018 by one or more data media interfaces. The memory 028 may include at least one program product having a set (e.g., at least one) of program modules that are configured to carry out the functions of embodiments of the present disclosure.

Program/utility 040, having a set (at least one) of program modules 042, may be stored in the system memory 028 by way of example, and not limitation, as well as an operating system, one or more disclosure programs, other program modules, and program data. Each of these examples or a certain combination thereof might include an implementation of a networking environment. Program modules 042 generally carry out the functions and/or methodologies of embodiments of the present disclosure.

Computer system/server 012 may also communicate with one or more external devices 014 such as a keyboard, a pointing device, a display 024, etc.; with one or more devices that enable a user to interact with computer system/server 012; and/or with any devices (e.g., network card, modem, etc.) that enable computer system/server 012 to communicate with one or more other computing devices. Such communication can occur via Input/Output (I/O) interfaces 022. Still yet, computer system/server 012 can communicate with one or more networks such as a local area network (LAN), a general wide area network (WAN), and/or a public network (e.g., the Internet) via network adapter 020. As depicted in FIG. 5, network adapter 020 communicates with the other communication modules of computer system/server 012 via bus 018. It should be understood that although not shown, other hardware and/or software modules could be used in conjunction with computer system/server 012. Examples, include, but are not limited to: microcode, device drivers, redundant processing units, external disk drive arrays, RAID systems, tape drives, and data archival storage systems, etc.

The processing unit 016 executes functions and/or methods in the embodiments described in the present disclosure by running programs stored in the memory 028.

The above computer program may be stored in a computer storage medium, i.e., the computer storage medium is encoded with a computer program. The program, when executed by one or more computers, enables one or more computers to execute steps of the method and/or operations of the apparatus shown in the above embodiments of the present disclosure.

As time goes by and technologies develop, the meaning of medium is increasingly broad. A propagation channel of the computer program is no longer limited to tangible medium, and it may also be directly downloaded from the network. The computer-readable medium of the present embodiment may employ any combinations of one or more computer-readable media. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be any tangible medium that include or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Finally, it is appreciated that the above embodiments are only used to illustrate the technical solutions of the present disclosure, not to limit the present disclosure; although the present disclosure is described in detail with reference to the above embodiments, those having ordinary skill in the art should understand that they still can modify technical solutions recited in the aforesaid embodiments or equivalently replace partial technical features therein; these modifications or substitutions do not make essence of corresponding technical solutions depart from the spirit and scope of technical solutions of embodiments of the present disclosure.

What is claimed is:

1. An emoji searching method, wherein the method comprises:
receiving an image search text input by a user;
converting the image search text input by the user into a words form;
obtaining an image search result corresponding to the image search text in the words form;
returning the image search result to the user.

2. The emoji searching method according to claim 1, wherein
the image search text is an emoji; or
a text including an emoji and words.

3. The emoji searching method according to claim 2, wherein the converting the image search text input by the user into a words form comprises:
detecting whether the image search text input by the user includes an emoji;
looking up for a term result corresponding to the emoji included in the image search text input by the user;
using the term result to replace the emoji, and converting the image search text including the emoji into the image search text in the words form.

4. The emoji searching method according to claim 2, wherein the detecting whether the image search text input by the user includes an emoji comprises:
converting the image search text input by the user into a unicode code; performing regular expression judgment for the unicode code to screen out an emoji unicode.

5. The emoji searching method according to claim 3, wherein the obtaining an image search result corresponding to the image search text in the words form comprises:
obtaining a search result item according to the image search text in the words form acquired from conversion.

6. The emoji searching method according to claim 5, wherein the search result item is generated by the following steps:
after receiving the image search text in the words form acquired from conversion, performing search in pre-built image text information indices to obtain an index matched with the image search text in the words form acquired from conversion; then obtaining an image corresponding to the index matched with the image search text in the words form acquired from conversion, and generating a search result item.

7. An apparatus, wherein the apparatus comprises:
one or more processors;
a storage device for storing one or more programs,
when said one or more programs are executed by said one or more processors, said one or more processors are enabled to implement the following operation:
receiving an image search text input by a user;
converting the image search text input by the user into a words form;
obtaining an image search result corresponding to the image search text in the words form;
returning the image search result to the user.

8. The apparatus according to claim 7, wherein
the image search text is an emoji; or
a text including an emoji and words.

9. The apparatus according to claim 8, wherein the converting the image search text input by the user into a words form comprises:
detecting whether the image search text input by the user includes an emoji;
looking up for a term result corresponding to the emoji included in the image search text input by the user;
using the term result to replace the emoji, and converting the image search text including the emoji into the image search text in the words form.

10. The apparatus according to claim 8, wherein the detecting whether the image search text input by the user includes an emoji comprises:
converting the image search text input by the user into a unicode code; performing regular expression judgment for the unicode code to screen out a emoji unicode.

11. The apparatus according to claim 9, wherein the obtaining an image search result corresponding to the image search text in the words form comprises:
obtaining a search result item according to the image search text in the words form acquired from conversion.

12. The apparatus according to claim 11, wherein the search result item is generated by the following operation:
after receiving the image search text in the words form acquired from conversion, performing search in pre-built image text information indices to obtain an index matched with the image search text in the words form acquired from conversion; then obtaining an image corresponding to the index matched with the image search text in the words form acquired from conversion, and generating a search result item.

13. A computer-readable storage medium on which a computer program is stored, wherein the program, when executed by a processor, implements the following operation:
receiving an image search text input by a user;
converting the image search text input by the user into a words form;
obtaining an image search result corresponding to the image search text in the words form;
returning the image search result to the user.

14. The computer-readable storage medium according to claim 13, wherein
the image search text is an emoji; or
a text including an emoji and words.

15. The computer-readable storage medium according to claim 14, wherein the converting the image search text input by the user into a words form comprises:
detecting whether the image search text input by the user includes an emoji;
looking up for a term result corresponding to the emoji included in the image search text input by the user;
using the term result to replace the emoji, and converting the image search text including the emoji into the image search text in the words form.

16. The computer-readable storage medium according to claim 14, wherein the detecting whether the image search text input by the user includes an emoji comprises:
converting the image search text input by the user into a unicode code; performing regular expression judgment for the unicode code to screen out a emoji unicode.

17. The computer-readable storage medium according to claim 15, wherein the obtaining an image search result corresponding to the image search text in the words form comprises:
obtaining a search result item according to the image search text in the words form acquired from conversion.

18. The computer-readable storage medium according to claim 17, wherein the search result item is generated by the following operation:
after receiving the image search text in the words form acquired from conversion, performing search in pre-built image text information indices to obtain an index matched with the image search text in the words form acquired from conversion; then obtaining an image corresponding to the index matched with the image search text in the words form acquired from conversion, and generating a search result item.
